(19) United States
(12) Patent Application Publication
(10) Pub. No.: US 2018/0333777 A1
(43) Pub. Date: Nov. 22, 2018

(54) POWDER PACKING MECHANISM

(71) Applicant: GENERAL ELECTRIC COMPANY, Schenectady, NY (US)

(72) Inventors: Emily BAUTISTA, Florence, KY (US); MacKenzie Ryan REDDING, Cincinnati, OH (US)

(21) Appl. No.: 15/599,154

(22) Filed: May 18, 2017

(51) Int. Cl. B22F 3/093; B22F 3/03; B33Y 70/00; B33Y 40/00; B30B 11/02

(52) U.S. Cl. CPC B22F 3/093; B22F 3/03; B22F 2998/10; B33Y 40/00; B30B 11/022; B33Y 70/00

(57) ABSTRACT

The present disclosure generally relates to powder packing for additive manufacturing (AM) methods and systems. Conventional powder packing methods have focused on leveling the bulk powder cone in the powder reservoir. Moreover, such methods may be manual and non-standardized, and they result in operator fatigue and potentially product inconsistencies. Powder packing according to the present disclosure improves standardization and reduces turnaround time, with the potential to lower the cost of AM.

### INTRODUCTION

The present disclosure generally relates to powder packing methods for use in powder-based additive manufacturing (AM) methods and systems.

### BACKGROUND

AM or additive printing processes generally involve the buildup of one or more materials to make a net or near net shape (NNS) object, in contrast to subtractive manufacturing methods. Though “additive manufacturing” is an industry standard term (ASTM F2792), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses electromagnetic radiation, such as a laser beam, to sinter or melt a powdered metal material, creating a solid three-dimensional object. Powder-based methods such as direct metal laser melting (DMLM) and selective laser melting (SLM) have been used to produce objects for a variety of industries.

Selective laser sintering, direct laser sintering, selective laser melting, and direct laser melting are common industry terms used to refer to producing three-dimensional (3D) objects by using a laser beam to sinter or melt a fine powder. For example, U.S. Pat. No. 4,863,538 and U.S. Pat. No. 5,460,758 describe conventional laser sintering techniques. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

FIG. 1 is schematic diagram showing a cross-sectional view of an exemplary conventional system 100 for direct metal laser sintering (DMLS) or direct metal laser melting (DMLM). The apparatus 100 builds objects, for example, the part 122, in a layer-by-layer manner by sintering or melting a powder material (not shown) using an energy beam 136 generated by a source such as a laser 120. The powder to be melted by the energy beam is supplied by a powder reservoir 126. The powder reservoir is also sometimes referred to as the powder dosing chamber. The powder is spread evenly over a build plate 114 using a recoater arm 116 travelling in direction 134 to maintain the powder at a level 118 and remove excess powder material extending above the powder level 118 to waste container 128. The energy beam 136 sinters or melts a cross sectional layer of the object being built under control of the galvo scanner 132. The build plate 114 is lowered and another layer of powder is spread over the build plate and object being built, followed by successive melting/sintering of the powder by the laser 120. The process is repeated until the part 122 is completely built up from the melted/sintered powder material.

Prior attempts to pack powder into the powder reservoir, or dosing chamber, have focused on leveling the bulk powder cone within the chamber. FIGS. 2-3 show two systems described in German Patent Application DE 102012008664 A1. In FIG. 2, the cross-section of the cover plate 215 is adapted to the internal cross-section of the dosing chamber 203, which allows it to be placed into the dosing chamber 203. In this way, it can press the bulk cones in the interior of the dosing chamber, while avoiding excess powder being pushed out over the edge region of the dosing chamber when the cover plate flattens the bulk cone. Vibration can be introduced into the cover plate 215. In order to smooth the surface of the building material, it is possible to provide vibration elements on the cover plate 215. As soon as the uppermost part of the bulk cone has been removed due to the vibrating cover plate 215, the cover plate 215 is further inserted into the dosing chamber 203 until the contact with the bulk cone again occurs. This allows the bulk cone to be graduated step by step.

FIG. 3 shows an alternative where a plurality of gas supply elements 318 are arranged on the underside of the cover plate 315. The gas feed elements 318 have a lance shape so that they can be immersed in the bulk cone 317 formed from the building material. By introducing the gas into the gas supply elements 318, the bulk cone 317 is whirled up and is thereby buried. For pressure compensation, an opening, which is sealed with a filter, can be located in the cover plate 315, which opening seals the dosing chamber 303 in a powder-tight manner. Therefore, only the gas introduced into the dosing chamber 303 can leave the dosing chamber 303, but not the construction material 305. The gas supply elements 318 are arranged with a particular advantage in a circular manner; they can also consist of a plurality of concentric circles. The center of these circles is the center of the outlet cone 316, the circle or the circles of gas supply elements 318 are arranged in such a way that respectively below the opening of the cover plate 315 through which the building material 305 falls into the dosing chamber 303.

Such methods along with known manual powder packing methods, e.g., with a trowel, can result in non-uniform packing density within the powder reservoir. Moreover, these techniques are often slow and can lead to operator fatigue and variation between batches. Accordingly, improved systems and method are needed to quickly and consistently pack powder into the powder reservoir.

### SUMMARY

The following presents a simplified summary of one or more aspects of the present disclosure in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In one aspect, the present disclosure relates to a method for preparing powder to be used in additive manufacturing, the method comprising steps a) to c). Step a) involves adding a first amount of powder to a powder reservoir. Step b) involves inserting a packing tool into the powder reservoir, wherein the packing tool comprises a plurality of vibration transmission elements extending downward. Step c) involves vibrating at least the plurality of vibration transmission elements. In some aspects, the method comprises adding a second amount of powder to the powder reservoir.

In some aspects, the method further comprises, before step a), feeding a powder into a funnel and allowing the powder to flow from the funnel through one or more tubes into the powder reservoir. In some aspects, the powder reservoir comprises a bottom plate, and the packing tool comprises a top plate, the plurality of vibration transmission elements, and at least one pressure sensor. In some aspects, the method further comprises vibrating at least the plurality of vibration transmission elements and simultaneously raising the bottom plate at a velocity, until a predetermined pressure limit is reached. In some aspects, the method further comprises raising the top plate and rotating the top plate by 90°.

In some aspects, the method further comprises lowering the top plate into the powder reservoir. In some aspects, the method further comprises repeating the steps of vibrating at least the plurality of vibration transmission elements and simultaneously raising the bottom plate at a velocity, until a predetermined pressure limit is reached; raising the top plate; rotating the top plate by 90°; and lowering the top plate into the powder reservoir, and repeating until the top plate has rotated by at least 360° relative to its original position.

In some aspects, the method further comprises, before allowing the powder to flow from the funnel through one or more tubes into the powder reservoir, lowering the bottom plate. In some aspects, the method further comprises, before allowing the powder to flow from the funnel through one or more tubes into the powder reservoir, locking the top plate location over the top of the powder reservoir. In some aspects, the method further comprises, before allowing the powder to flow from the funnel through one or more tubes into the powder reservoir, the step of raising the bottom plate until either the pressure sensor senses a powder packing limit, or the plurality of vibration transmission elements extending downward from the top plate contact the bottom plate.

In some aspects, the steps of vibrating at least the plurality of vibration transmission elements and simultaneously raising the bottom plate at a velocity, until a predetermined pressure limit is reached; raising the top plate; rotating the top plate by 90°; and lowering the top plate into the powder reservoir, pack an amount of the powder between the top and bottom plates. In some aspects, the powder reservoir is separable from the funnel, the one or more tubes, and the top plate.

In another aspect, the present disclosure relates to an apparatus for powder packing, comprising a powder funnel, one or more tubes connecting the powder funnel to a powder reservoir, a packing tool comprising a plurality of vibration transmission elements extending downward, and a vibration isolation ring around the one or more tubes. In some aspects, the packing tool comprises a top plate comprising the plurality of vibration transmission elements extending downward and further comprising a pressure sensor. In some aspects, the one or more tubes connecting the powder funnel to the powder reservoir can be open or closed. In some aspects, the powder reservoir comprises a bottom plate, and the plurality of vibration transmission elements extend downward from the top plate to the bottom plate. In some aspects, the powder reservoir is separable from the apparatus.

These and other aspects of the disclosure will become more fully understood upon a review of the detailed description, which follows.

### BRIEF DESCRIPTION OF THE DRAWINGS

FIG. 1 shows an exemplary conventional powder bed apparatus for additive manufacturing.

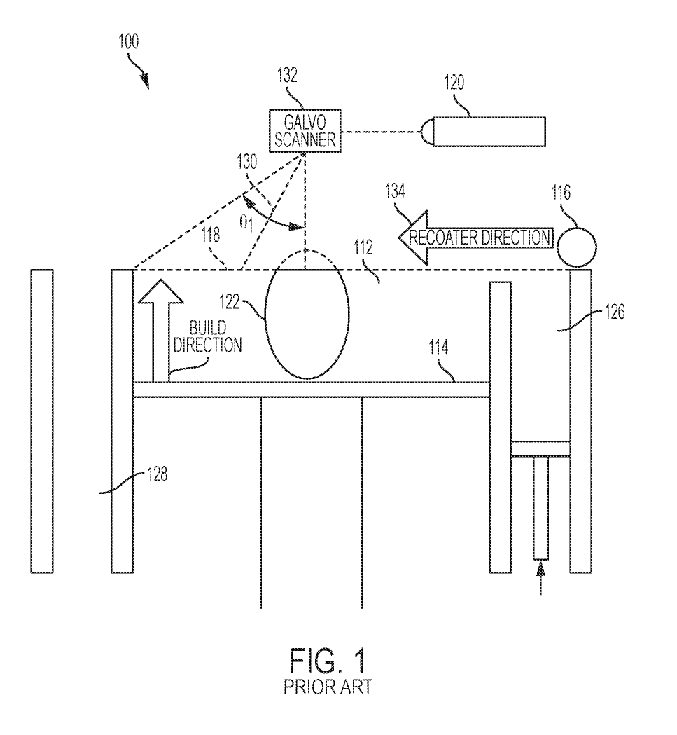

FIG. 2 shows a conventional powder packing apparatus including a cover plate.

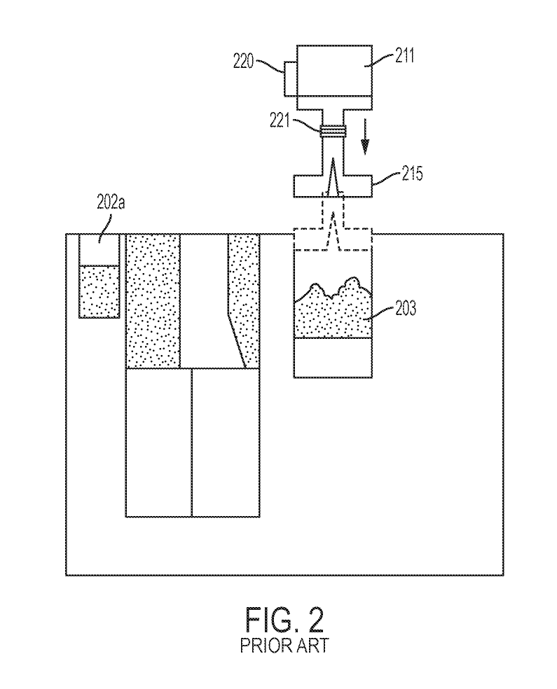

FIG. 3 shows a conventional powder packing apparatus including gas supply elements.

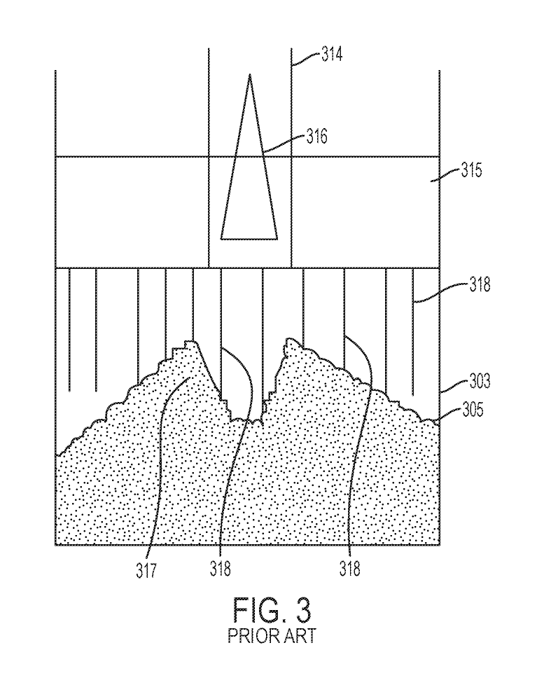

FIG. 4A shows an example of an apparatus for powder packing according to the present disclosure.

FIG. 4B shows an underside view of an exemplary packing tool for use with the present disclosure.

FIGS. 5A-5C show a schematic of a method of powder packing according to the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present application is directed to automated methods of preparing powder to be used in additive manufacturing. Such methods differ from conventional powder preparation methods by removing manual force and non-standardized equipment and procedures. By automating the powder packing process, the present disclosure improves process standardization, reduces physical wear on the operator, and improves machine turnaround time (e.g., by minimizing preparation time).

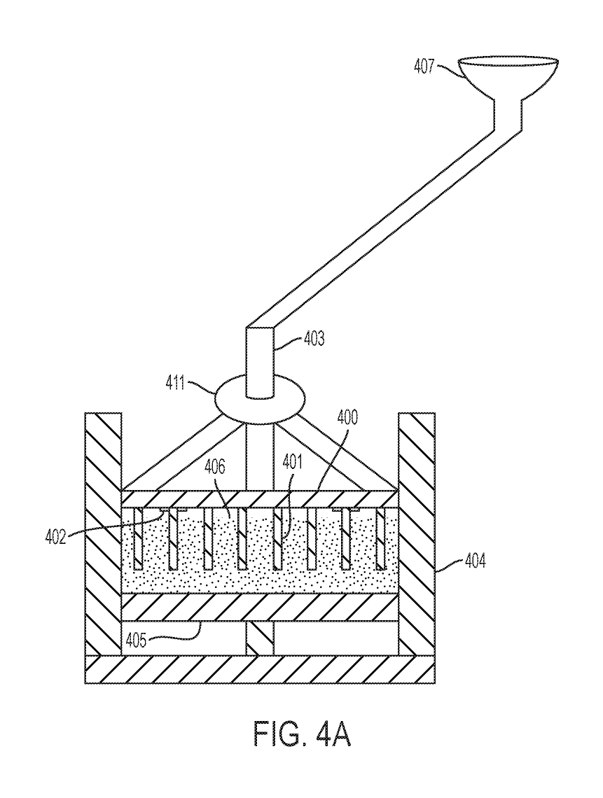

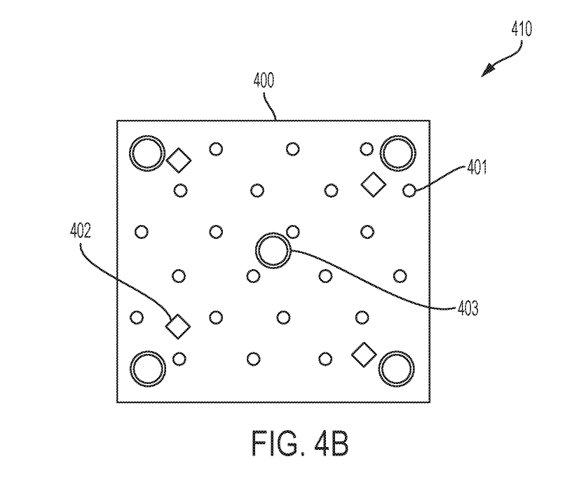

FIG. 4A shows an example of an apparatus for use according to the present disclosure. A first amount of powder 406 is added to powder reservoir 404. In some aspects, powder reservoir 404 may comprise a bottom plate 405. In some aspects, the powder may be added via a funnel 407 and one or more tubes 403 running from the funnel 407. In some aspects, the powder may be allowed to flow from funnel 407 through one or more tubes 403 into the powder reservoir 404 for an amount of time. In some aspects, the one or more tubes 403 may be open or closed. In some aspects, bottom plate 405 may be lowered into a powder reservoir 404 before allowing powder to flow from the funnel 407 through one or more tubes 403 into the reservoir 404. Packing tool 410, comprising a plurality of vibration transmission elements 401 extending downward, may be inserted into the powder-containing reservoir 404 and vibrated, to compact the powder in the reservoir 404 and form a layer of compacted powder (not shown). The apparatus (FIG. 4A) may further comprise a vibration isolation ring 411, which may help damp and/or isolate vibrations and localize them to the packing tool 410. After compacting the first amount of powder, a second amount of powder may be added over the layer of compacted powder, and the process may be repeated.

FIG. 4B shows an example of the underside of a packing tool 410 for use with the apparatus and method of the present disclosure. Packing tool 410 may comprise a top plate 400 comprising the plurality of vibration transmission elements 401 extending downward and may further comprise one or more pressure sensors 402. In some aspects, the location of the top plate 400 or the packing tool 410 may be locked over the top of powder reservoir 404 before allowing powder to flow from the funnel 407 through one or more tubes 403 into the powder reservoir 404. In some aspects, the one or more tubes 403 run from the funnel 407 to the center of the top plate 400. In some aspects, the one or more tubes 403 run from the funnel 407 to the center and one or more corners of the top plate 400. In some aspects, before allowing the powder to flow from the funnel 407 through one or more tubes 403 into the powder reservoir 404, the bottom plate 405 may be raised until either the one or more pressure sensors 402 sense a powder packing limit or the plurality of vibration transmission elements 401 extending downward from top plate 400 contact the bottom plate 405.

The plurality of vibration transmission elements 401 may extend downward any length; it is within the knowledge of those of ordinary skill in the art to determine appropriate lengths for the plurality of vibration transmission elements 401. In some aspects, the plurality of vibration transmission elements 401 extend downward from the packing tool 410 by a length that is a function of the height of the powder reservoir 404 and/or the height of the powder in the powder reservoir 404. For example, a taller powder reservoir 404 or a taller powder height may be used with a packing tool 410 with a longer plurality of vibration transmission elements 401. In some aspects, the ratio of the height of the powder reservoir 404 to the length of the plurality of vibration transmission elements 401 may range from 4:1 to 8:1, or any ratio in between. The vibration transmission elements 401 are preferably suited to transmit vibration from the packing tool to the underlying powder. In one embodiment, the vibration is transmitted through solid cylindrical vibration transmission elements 401. The shape of the vibration transmission elements may also be another shape such as square or rectangular.

The powder reservoir 404 may be of any dimensions suitable for use with the present method and apparatus. In some aspects, the powder reservoir 404 has a rectangular or square base with sidewalls rising from the edges of the base. In some aspects, the powder reservoir 404 has a wall height of no more than 4 feet. In some aspects, the powder reservoir 404 has a wall height of no more than 3 feet. In some aspects, the powder reservoir 404 has a rectangular or square base measuring no less than 1 foot long on at least one side. In some aspects, the powder reservoir 404 has a square base measuring no more than 5 feet long on at least one side.

The plurality of vibration transmission elements 401 may be of any thickness. In some aspects, the plurality of protrusions have a thickness of no greater than 1.5 inches. In some aspects, the plurality of protrusions have a thickness of no less than 0.25 inches.

The plurality of vibration transmission elements 401 may comprise any number of vibration transmission elements, or any array number. In some aspects, the number of vibration transmission elements is a function of the width and/or depth of the powder reservoir 404. In some aspects, the number of vibration transmission elements is a function of the thickness of the vibration transmission elements. For example, the smaller the vibration transmission element thickness, the greater the number of vibration transmission elements. Without wishing to be bound to any particular theory, it is believed that there may be an attenuation zone around each vibration transmission element that provides improved powder packing capabilities relative to the use of a vibrating plate alone. In addition, the present invention provides improved powder packing without introduction of gas or any other means powder packing, such as manual packing with a trowel.

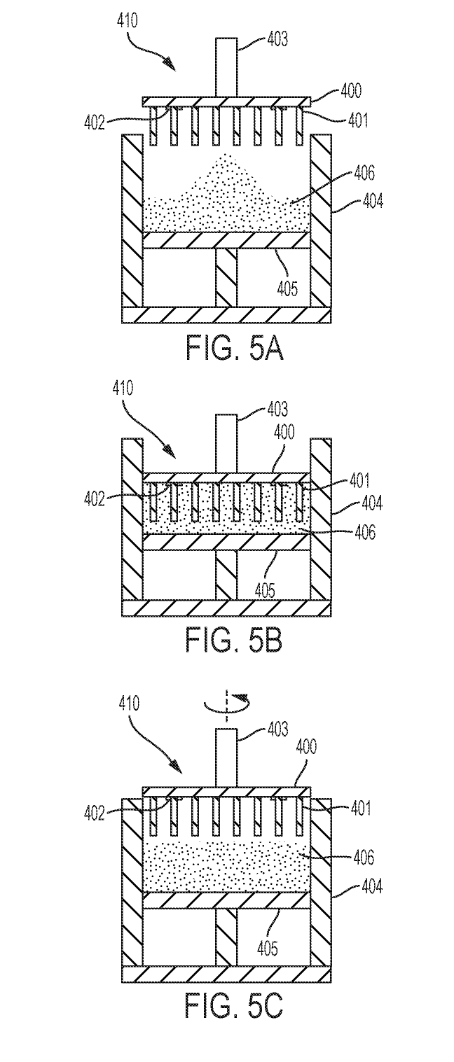

FIGS. 5A-5C show a schematic of steps of using the apparatus of the present disclosure, according to some aspects. In FIG. 5A, packing tool 410 is lowered into powder reservoir 404, which contains a first amount of powder 406, which typically has a bulk powder cone formed by the pouring action. As packing tool 410 is lowered, the plurality of vibration transmission elements 401 become immersed in the first amount of powder 406 (FIG. 5B). Once immersed to a desired depth, the packing tool 410 is vibrated, and the plurality of vibration transmission elements 401 transmit the vibrations down into the powder. In some aspects, the top plate 400 is vibrated while being lowered. In some aspects, the top plate 400 is lowered while the bottom plate 405 is simultaneously raised. The plurality of protrusions 401 may be vibrated while simultaneously raising the bottom plate 405 at a velocity, until a predetermined pressure limit is reached, as detected by the one or more pressure gauges 402. In some aspects, the pressure limit and/or the velocity at which the bottom plate 405 is raised may be controlled using a computer. The plurality of vibration transmission elements 401 is believed to extend the vibration down into the powder between top plate 400 and bottom plate 405. The use of a predetermined pressure limit may improve consistency in powder packing. Vibration may be at any suitable frequency and for any suitable duration of time.

After a suitable or desired vibration duration, the packing tool 410 may be raised out of powder reservoir 404 (FIG. 5C). Packing tool 410 may be raised, rotated by 90°, and lowered into the powder reservoir 404. The steps of vibrating at least the plurality of vibration transmission elements 401 and simultaneously raising the bottom plate 405 at a velocity until a predetermined pressure limit is reached, raising the packing tool 410, rotating the packing tool 410 by 90°, and lowering the packing tool 410 into the powder reservoir 404 may be repeated. In some aspects, the steps pack an amount of powder between top plate 400 and bottom plate 405. In some aspects, the steps may be repeated until the packing tool 410 has rotated by a total of 360° or a multiple thereof relative to its original position. In some aspects, the packing tool 410 is rotated by 360° or a multiple thereof relative to its original position, such that any holes created in the powder by the plurality of vibration transmission elements 401 are filled in by powder during or as a result of the rotation(s).

In some aspects, a computer may also be used to control movements of the packing tool 410, initiation of powder feed into funnel 407, initiation of vibration of vibration transmission elements 401, and raising and lowering of bottom plate 405. Raising and lowering of top plate 400, packing tool 410, and/or bottom plate 405 may be by any suitable distance(s); determining such distance(s) is within the knowledge of those of ordinary skill in the art.

In some aspects, the apparatus comprises funnel 407, one or more tubes 403, vibration isolation ring 411, and packing tool 410, and may be separable from powder reservoir 404. The apparatus may be separable from or joinable to the powder reservoir 404 by any suitable means known to those of ordinary skill in the art.

The apparatus, funnel 407, one or more tubes 403, vibration isolation ring 411, packing tool 410, top plate 400, plurality of vibration transmission elements 401, powder reservoir 404, bottom plate 405, and one or more pressure sensors 402 may be composed of any suitable materials known in the art. Preferably, parts that may come into contact with the powder, such as funnel 407, one or more tubes 403, packing tool 410, top plate 400, plurality of vibration transmission elements 401, one or more pressure sensors 402, powder reservoir 404, and bottom plate 405, do not contaminate the powder. In addition, the apparatus, funnel 407, one or more tubes 403, vibration isolation ring 411, packing tool 410, top plate 400, plurality of vibration transmission elements 401, powder reservoir 404, bottom plate 405, and one or more pressure sensors 402 are preferably made of materials that can withstand vibration at the frequency and duration used according to the present disclosure.

The methods and apparatus of the present disclosure may be used with any powder-based additive manufacturing methods and apparatuses, such as DMLM or SLM. The methods and apparatus of the present disclosure may be used with any powder material; preferably, the powder does not react with the material(s) from which the apparatus is made.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

1. A method for preparing powder to be used in additive manufacturing, comprising:
a) adding a first amount of powder to a powder reservoir;
b) inserting a packing tool into the powder reservoir, wherein the packing tool comprises a plurality of vibration transmission elements extending downward; and
c) vibrating at least the plurality of vibration transmission elements.

2. The method of claim 1, comprising adding a second amount of powder to the powder reservoir.

3. The method of claim 1, further comprising, before step a), feeding a powder into a funnel and allowing the powder to flow from the funnel through one or more tubes into the powder reservoir.

4. The method of claim 3, wherein the powder reservoir comprises a bottom plate, and the packing tool comprises a top plate, the plurality of vibration transmission elements, and at least one pressure sensor.

5. The method of claim 4, further comprising vibrating at least the plurality of vibration transmission elements and simultaneously raising the bottom plate at a velocity, until a predetermined pressure limit is reached.

6. The method of claim 5, further comprising
raising the top plate; and
rotating the top plate by 90°.

7. The method of claim 6, further comprising lowering the top plate into the powder reservoir.

8. The method of claim 7, further comprising repeating the steps of
vibrating at least the plurality of vibration transmission elements and simultaneously raising the bottom plate at a velocity, until a predetermined pressure limit is reached;
raising the top plate;
rotating the top plate by 90°; and
lowering the top plate into the powder reservoir,
and repeating until the top plate has rotated by at least 360° relative to its original position.

9. The method of claim 4, further comprising, before allowing the powder to flow from the funnel through one or more tubes into the powder reservoir, lowering the bottom plate.

10. The method of claim 9, further comprising, before allowing the powder to flow from the funnel through one or more tubes into the powder reservoir, locking the top plate location over the top of the powder reservoir.

11. The method of claim 9, further comprising, before allowing the powder to flow from the funnel through one or more tubes into the powder reservoir, the step of raising the bottom plate until either the pressure sensor senses a powder packing limit, or the plurality of vibration transmission elements extending downward from the top plate contact the bottom plate.

12. The method of claim 7, wherein the steps of
vibrating at least the plurality of vibration transmission elements and simultaneously raising the bottom plate at a velocity, until a predetermined pressure limit is reached;
raising the top plate;
rotating the top plate by 90°; and
lowering the top plate into the powder reservoir,
pack an amount of the powder between the top and bottom plates.

13. The method of claim 9, wherein the powder reservoir is separable from the funnel, the one or more tubes, and the top plate.

14. An apparatus for powder packing, comprising:
a powder funnel;
one or more tubes connecting the powder funnel to a powder reservoir;
a packing tool comprising a plurality of vibration transmission elements extending downward; and
a vibration isolation ring around the one or more tubes.

15. The apparatus of claim 14, wherein the packing tool comprises a top plate comprising the plurality of vibration transmission elements extending downward and further comprising a pressure sensor.

16. The apparatus of claim 14, wherein the one or more tubes connecting the powder funnel to the powder reservoir can be open or closed.

17. The apparatus of claim 15, wherein the powder reservoir comprises a bottom plate, and the plurality of vibration transmission elements extend downward from the top plate to the bottom plate.

18. The apparatus of claim 15, wherein the powder reservoir is separable from the apparatus.
